(19) United States
(12) Patent Application Publication
(10) Pub. No.: US 2021/0074115 A1
(43) Pub. Date: Mar. 11, 2021

(54) Autonomous off-grid vending machine with thermo-electric climate control

(71) Applicant: Abhishek Ram, North Attleboro, MA (US)

(72) Inventor: Abhishek Ram, North Attleboro, MA (US)

(21) Appl. No.: 16/568,159

(22) Filed: Sep. 11, 2019

(51) Int. Cl. G07F 9/10; H02S 10/30

(52) U.S. Cl. CPC G07F 9/105; H02S 10/30

(57) ABSTRACT

An improved storage and dispensing device that is energy self-sufficient, energy efficient, and structurally robust. This device consists of a set of photovoltaic cells (1006) and batteries (1005) that enable the machine to be rechargeable using solar power and operate with energy self-sufficiency. It utilizes Peltier (thermo-electric) cooling (1003) and achieves energy efficiency and space reduction by removing machine components that have moving parts that contribute to energy losses due to friction. It utilizes a concrete (1001) and plastic aggregate (1002) for storage enclosure construction to achieve structural robustness and thermal insulation to improve energy efficiency. A dispensing tray 1007 with a stepper motor 30071 and belt 30072 holds the dispensed object and delivers it when required.

### CROSS-REFERENCE TO RELATED APPLICATIONS

This application claims the benefit of provisional patent application Ser. No. 62/730,666, filed 2018 Sep. 13 by the present inventor.

### BACKGROUND—PRIOR ART

The following is a tabulation of some prior art that presently appears relevant:

U.S. Patents

| Pat. No. | Kind Code | Issue Date | Patentee |
|---|---|---|---|
| 4,373,955 | A | 1983 Feb. 15 | Bouchard et. al. |
| 8,921,463 | B1 | 2014 Dec. 30 | Alqahtani et. al. |
| 6,499,306 | B2 | 2002 Dec. 31 | Gillen |
| 6,612,116 | B2 | 2003 Sep. 2 | Fu et. al. |
| 20020104318 | A1 | 2002 Aug. 8 | Jaafar et. al. |
| 20100252569 | A1 | 2016 Jan. 26 | Pelfrey |
| 6,522,252 | B2 | 2003 Feb. 18 | Horibe et. al. |
| 6,341,271 | B1 | 2002 Jan. 22 | Salvo et. al. |
| 20140201042 | A1 | 2014 Jul. 17 | Meyer |

Foreign Patent Documents

| Foreign Doc. | | | | |
|---|---|---|---|---|
| Nr. | Cntry. Code | Kind Code | Pub. Dt. | Patentee |
| 1173513 | CA | A | 1984 Aug. 28 | Beitner |

Dispensing machines are large devices that are operated using electric power from the power grid and use refrigeration technology involving compressors and motors. They rely on a reliable source of electric power for continuous operation and ensuring the dispensed items are maintained at the required temperature. These design elements restrict the use of dispensing machines to well controlled environments and thereby restrict the widespread use in geographical areas that do not have a reliable power source due to lack of economic development or natural calamities.

In terms of Claim I, the only related patent is U.S. Pat. No. 4,373,955. This patent, however, details the formation and generation of lightweight concrete, and does not place claims on the applications. Our patent instead lays claim on an application of concrete, and not on a specific method for making said concrete.

In terms of both Claims I and II, concrete and plastic is not used in conjunction for a specific application. The closest patent available that involves concrete and plastic is U.S. Pat. No. 8,921,463B1, which is a patent relating to the aggregation of concrete and recyclable plastic. This patent, discusses the method for creating a concrete plastic aggregate, and does not place claims on any potential applications for it. More particularly, the above patent does not lay claims to using the proposed aggregate for any application of insulation to prevent heat loss, cooling, or for creating an enclosure of any sort. In contrast, our patent does not lay claim or describe methods for developing an aggregate, but simply choose to use the said concrete and recycled plastic aggregate for structural and thermal use in the dispensing machine.

With regards to Claim III, a patent that utilizes Peltier coolers is U.S. Pat. No. 6,499,306. This patent relates to the use of a Peltier cooler with a control system to allow for variable directed thermal output. This patent, however, does not place a claim on using it within an enclosure of any kind. The aforementioned patent even specifies that the Peltier system needs protection from moisture, but does not lay claim to an enclosure being a solution to protection from moisture. In contrast, our patent simply uses a system like the one described in the above patent for our machine function, but our patent goes a step further to demonstrate the use of this Peltier cooler setup within a dispensing machine.

Another relevant patent to the same aforementioned claim is Patent No. CA1173513A. This patent is for a rectangular box with an openable front door that is cooled using Peltier coolers. It however, lays not claim to the use of dispensers within the system nor does it lay claim to any distinctions in the insulation materials. As a matter of fact, it is a self-described “Refrigerator”, while our claimed machine is a dispenser capable of both cooling and heating, as the need arises.

Another relevant patent to the same aforementioned claim is U.S. Pat. No. 6,612,116B2. This patent is for food storage system with multiple chambers and is cooled using Peltier coolers. It however, lays not claim to the use of dispensers within the system nor does it lay claim to any distinctions in the insulation materials. As a matter of fact, it too is a self-described “storage compartment incorporating a quick chill” feature, while our claimed machine is a dispenser capable of both cooling and heating, as the need arises.

In relation to both Claims IV and V, there are multiple existing patents that are relevant. For example, Patent No. US20020104318A1, relates to a portable cooling unit that utilizes Peltier tiles to enable directed thermal input to the system, a solar panel that is used to provide power to the Peltier tiles, and finally an implemented thermal control system. This patent, however, does not lay claim on the type of cabinet to be utilized with the system, nor does it even directly mention any form of material storage or dispensing as part of this system. This distinction separates our patent from this one, as our patent lays claim to a specific insulation method and system for use in a dispensing machine.

Another patent that relates to both Claims IV and V is Patent No. US20100252569. This is very similar to the previously aforementioned Patent No. US20020104318A1, save for the addition of a storage space in this new patent. To clarify, this new patent lays claim on the addition of a storage space comprised of “thermally insulating materials” with top wall that is openable.

What separates our design from this patent's design is that we are specifying the thermally insulating materials that we intend to use as part of the design. Whereas they leave their material choices unspecified, Claims I and II of our patent specify the use of concrete and recyclable plastic together for creating the storage container. Additionally, the above patent specifies that its design is miniature in scale. To clarify, it is used for storage of thermally unstable substances, such as medications. Our dispensing machine, however, would be much larger than this one is, and it is also not specifically for storage of medication.

Now, I will discuss patents relevant to Claim VI. The first patent is U.S. Pat. No. 6,522,252B2. This patent relates to the use of pressure sensors in order to maintain security of a system that has various doors. The described system of the patent can track whether doors are open or closed based on abrupt changes in pressure on both sides. Presumably, this system can be used to ward off intruders and supply warnings of different types of structural compromise.

This patent demonstrates the viability of the use of pressure sensors to maintain security and machine integrity. What separates our patent from the one above is that our patent only utilizes a security similar to that of the other patent, and does not claim to develop it from scratch. Additionally, while the above mentioned patent utilizes pressure sensors to measure changes in air pressure consistent with opening/closing a door, our patent utilizes pressure sensors in order to measure solid contact caused by external stimuli. Finally, the above patent does not claim to use this system for any sort of dispensing machine, and by extension, does not lay claim to using the system in conjunction with any of the other components we have mentioned, save the door.

The second patent that is relevant to Claim VI is U.S. Pat. No. 6,341,271B1. This patent pertains to an inventory management method within a storage enclosure or receptacle. While it is an inventory management method directed toward vendors or dispensing machines, this above patent does not specify a method for tracking the amount of a product in each section of the receptacle. In contrast to this, our patent would utilize a system like this and supply a method for tracking the amount of products via the pressure sensors.

A third patent that is relevant to Claim VI is Patent No. US20140201042A1. This patent explains the design of a weight sensing system to be utilized on a set of shelves in a retail setting. In an implementation, this can be used to track and determine the product levels on the shelves so as to track the need for restocking.

This system is very similar to part of the system that would be needed by our patent in order to track products. What is not explicitly stated within the above mentioned patent is the use of this system in a dispensing machine of any kind, unlike our patent. Additionally, there is no mention of using this weight sensing system partly also as a security mechanism.

### SUMMARY

The present invention is an autonomous dispensing machine that is versatile in placeability. It is both remotely placeable and self-sufficient, only relying on restocking by an outside source.

To support remote placeability, the machine is relatively small in size and lightweight compared to existing dispensing machines. This allows it to be movable by only a couple of individuals of average strength. The present invention eliminates many conventional heavyweight components such as a compressor and motor drive for the cooling system resulting in a lightweight dispensing machine. The present invention uses Peltier coolers for effective cooling and heating without compromising the lightweight design.

Also, to support remote placement of the dispensing machine while minimizing the effect on the environment, the present invention uses concrete and recycled plastic aggregate which is superior to using the traditional polyurethane foam for insulation. The amount of concrete used does not contribute to the weight significantly because the machine is relatively small in size compared to existing dispensing machines

Also, to support energy independence, the present invention uses rechargeable batteries in conjunction with a set of photovoltaic cells to supply power for machine operation. This design ensures that the machine does not need to be plugged into any sort of electrical grid. This supports the ability of placing the dispensing machine in remote locations away from the electrical grid.

Also, to support minimal maintenance, the present invention uses Peltier coolers. This design supports greatly reduced maintenance compared to refrigeration systems that use motors and compressors.

Finally, to support autonomous operation, the present invention uses pressure sensors to track inventory for monitoring inventory and identifying unauthorized access. This design eliminates the need for constant human surveillance for managing the dispensed items and theft prevention.

[symbol]

### DRAWINGS—FIGURES

In the drawings, closely related figures have the same number but different alphabet suffixes.

FIG. 1 is a front view of the dispensing machine with the front panel removed to show all required components for full machine function.

FIG. 2 is a cross-section view of the dispensing machine. The view shown is Section A-A and shows the internal view of the machine when viewing it from the side.

FIG. 3 is a view of a single dispensing tray 1007 showing the belt 30072 and stepper motor 30071.

FIG. 4 is a flow chart for the control program within control system 1009.

[symbol]

### DETAILED DESCRIPTION

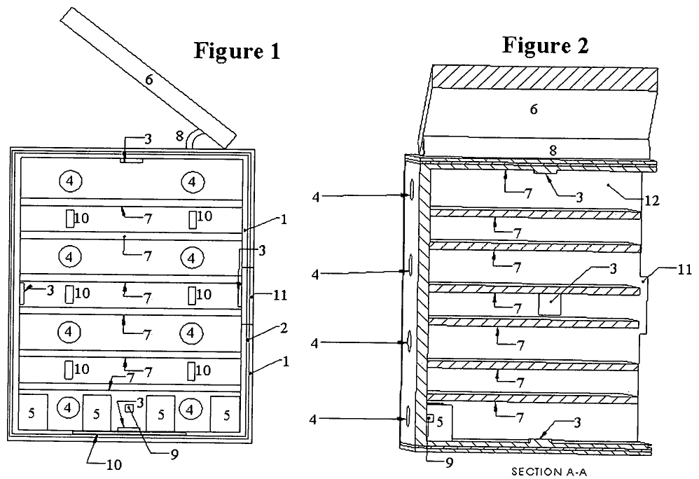

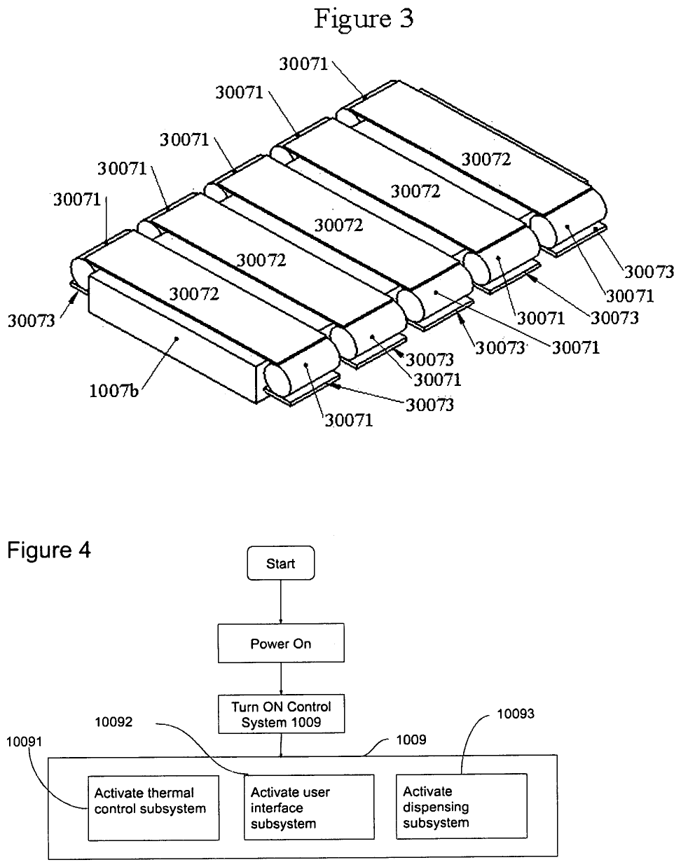

The aforementioned dispensing machine will now be discussed in context to FIG. 1, FIG. 2, FIG. 3 and FIG. 4.

The present invention is now described.

Firstly, 1001 is the concrete casing that is to be utilized in order to create the walls of the enclosure. Concrete is very well known for its relative high strength to weight ratio. Combined with the low costs associated with it, it is a vital and ideal component that is part of the present invention.

Next, 1002 is the plastic fillings in granulated form that is dispersed into the concrete casing 1001. The use of plastic is necessary for improving both thermal and structural integrity of the concrete casing 1001. Although concrete has a high strength to weight ratio, it is also very brittle. Additionally, concrete is also a relatively poor insulator of heat and is also very porous. To ensure that the concrete casing 1001 can withstand high impacts due to external stimuli, we embed plastic fillings 1002 within the concrete. Plastic is also an insulator, so it will reduce heat loss (or limit heat entry) into the system. Finally, plastic is also hydrophobic, meaning that it would not allow water to pass through the walls. Since concrete is an aggregate it is capable of embedding plastic fillings 1002 easily.

Next, 1003 is a set of Peltier coolers. They are used to maintain a preset temperature within the enclosure of the present invention. A set of fans 1004 is used for circulating the air within the enclosure to ensure uniform spatial temperature distribution.

Next, 1006 is a set of photovoltaic cells placed on top of the concrete casing 1001. 1008 is an adjustable bracket to ensure that photovoltaic cells 1006 is oriented at a specific angle to maximize the amount of solar radiation received to ensure adequate power is generated.

Next, 1005 is a set of direct current (DC) batteries. It stores power produced by 1006 photovoltaic cells and distributes power to Peltier coolers 1003, fans 1004, and dispensing tray 1007.

Next, 1007 is the dispensing tray. It contains the stepper motor 30071, belt 30072, and 30073 support bracket.

Next, 1009 is the control system. It contains the computer program to control the thermal 10091, user interface 10092, and dispensing 10093 subsystems.

Next, 1010 is the pressure sensor. As the items contained on the dispensing tray is reduced, the pressure sensor reading will change and will be used for estimating inventory within the dispensing machine. The pressure sensor 1010 can also be used to detect events like theft, ground disturbances, and unauthorized access.

### Operation

A description of the present invention follows.

First, the set of photovoltaic cells 1006 generates direct current (DC) when solar radiation is incident on the panels. The photovoltaic cells 1006 is connected to a set of batteries capable of storing direct current. As the battery current levels fall due to usage within the present invention, the direct current from photovoltaic cells 1006 will recharge the batteries.

Next, the present invention is turned on for operation. The control system 1009 is turned on and draws power from the batteries 1006. The program within the control system has the thermal control subsystem 10091, the user interface subsystem 10092, and the dispensing control subsystem 10093.

Next, if the temperature inside the present invention rises beyond a set point temperature the thermal control subsystem 10091 will turn on the Peltier coolers 1003 to begin the cooling process. This operation continues until the temperature reaches the set point temperature.

Next, the dispensing tray 1007, has the dispensed object placed on the belt 30072. When a dispensing tray location is received from the user interface subsystem 10092, the stepper motor 30071 advances to move the dispensed object to the delivery opening of the concrete enclosure 1001.

Next, the user interface subsystem 10092 receives a selection, it activates the dispensing subsystem 10093 to initiate the dispensing of stored object.

At 10091, the thermal control subsystem follows this sequence of operations:
1. Sample temperature inside enclosure
2. If temp is below required temperature switch to heating mode
3. If temp is above required temperature switch to cooling mode
4. Pause for one minute
5. Repeat step 1
   At 10092, the user interface subsystem follows this sequence of operations:
1. Load the pre-defined lookup table of items and tray locations into memory from built-in storage drive
2. Display all dispensed items on touch sensitive screen in specific locations on the screen
3. If item is touched, use the touch screen location to determine the pre-defined tray location in a lookup table in memory
4. Check if dispensing system is OFF, then turn ON dispensing system.
5. Send tray location to dispensing system
6. Wait for signal from dispensing system for 5 minutes
   a. If no signal is received display error message and power down system.
   b. If signal received before 5 minutes go to step 2.
      At 10093, the dispensing subsystem follows this sequence of operations:
1. Use tray location to turn on stepper motor for a fixed duration to dispense product
2. Update tray weight in memory
3. Reduce inventory count in the storage drive
4. Send signal to user interface subsystem

### ALTERNATIVE EMBODIMENTS

There are various possibilities with regard to use of the present invention. The dispensing machine system may be used as a storage system without the dispensing mechanism.

To support remote placeability, the said machine is relatively small in size and lightweight due to the use of Peltier coolers.

Also, to minimize the effect on the environment, the said machine uses concrete and recycled plastic aggregate instead of traditional polyurethane foam for insulation.

Also, to support energy independence, the said machine uses rechargeable batteries in conjunction with a set of photovoltaic cells to supply power for machine operation.

Finally, to support minimal maintenance, the said invention uses Peltier coolers for greatly reduced maintenance compared to refrigeration systems that use motors and compressors.

### CONCLUSION, RAMIFICATION, AND SCOPE

The present invention and its embodiments has multiple uses for storing and dispensing products while providing an energy efficient and secure dispensing machine:
it permits the storage of over-the-counter medications in remote locations or in locations affected by natural disasters;
it permits the storage of non-perishable food items in remote locations or in locations affected by natural disasters or in locations where access if limited due to security restrictions;

Although the description above contains many specificities, these should not be construed as limiting the scope of the embodiments but as merely providing illustrations of several embodiments. For example the enclosure can have different shapes such as circular, oval, triangular, etc. The renewable energy source can be from wind power, geo-thermal, etc. energy sources. The dispensing mechanism can be a pick & place robot, gravity based delivery of product, etc. The cooling system can be a vapor evaporation system, heat pump, etc. The machine enclosure can use concrete aggregate with other recycled materials like cardboard, rubber, etc. Thus the scope of the embodiments should be determined by the appended claims and their legal equivalents, rather than by the examples given.

1. What is claimed is a dispensing machine, comprising of a novel integration of existing technologies, wherein the machine will have:
I. a set of concrete walls joined together to provide mechanical strength,
II. with recycled material fragments embedded in said walls to reduce heat loss, reduce weight, while increasing flexibility,
III. a set of thermo-electric cooler heat sinks (also known as Peltier coolers) mounted on said walls for cooling the air inside said enclosure,
IV. a battery mounted inside the said enclosure to store energy for later use,
V. a set of solar panels mounted on top of said enclosure to generate electricity to charge a battery,
VI. a set of piezoelectric pressure sensors placed around the perimeter of the inside of the enclosure as a method of security to prevent compromise of the machine's integrity,
whereby said dispensing machine will store physical objects securely while maintaining a preset temperature within the said enclosure.
